(19) United States
(12) Patent Application Publication
(10) Pub. No.: US 2025/0210261 A1
(43) Pub. Date: Jun. 26, 2025

(54) MULTILAYER CERAMIC CAPACITOR AND MANUFACTURING METHOD THEREOF

(71) Applicant: SAMSUNG ELECTRO-MECHANICS CO., LTD., Suwon-si (KR)

(72) Inventors: Minhee Kim, Suwon-si (KR); Heesun Chun, Suwon-si (KR); Sun-Min Jung, Suwon-si (KR); Gil Seong Kang, Suwon-si (KR); Jiyoung Lee, Suwon-si (KR); Yongjun Gong, Suwon-si (KR)

(73) Assignee: SAMSUNG ELECTRO-MECHANICS CO., LTD., Suwon-si (KR)

(21) Appl. No.: 18/817,894

(22) Filed: Aug. 28, 2024

(30) Foreign Application Priority Data
Dec. 26, 2023 (KR) 10-2023-0191728

(51) Int. Cl. H01G 4/12; C04B 35/468; C04B 37/00; H01G 4/30

(52) U.S. Cl. CPC H01G 4/1227; C04B 35/4682; C04B 37/001; H01G 4/30; C04B 2235/3217; C04B 2235/3224; C04B 2235/3236; C04B 2235/3418; C04B 2235/6027; C04B 2235/768; C04B 2235/785; C04B 2235/85; C04B 2237/346; C04B 2237/68

(57) ABSTRACT

A multilayer ceramic capacitor may include a capacitor body including a dielectric layer and an internal electrode layer, and an external electrode disposed outside the capacitor body, where the dielectric layer may include at least one dielectric grain, where the dielectric grain may include a barium titanate-based primary component including barium (Ba) and titanium (Ti), and a secondary component, where the secondary component may include samarium (Sm) as a first secondary component, and a second secondary component, where the second secondary component may include lanthanum (La), cerium (Ce), praseodymium (Pr), neodymium (Nd), promethium (Pm), europium (Eu), gadolinium (Gd), terbium (Tb), dysprosium (Dy), holmium (Ho), erbium (Er), thulium (Tm), ytterbium (Yb), lutetium (Lu), or a combination thereof, and where the second secondary component may be included in an amount ranging from 1.2 atom % to 2.0 atom % based on 100 atom % of titanium (Ti).

### CROSS-REFERENCE TO RELATED APPLICATION

This application claims priority to and the benefit of Korean Patent Application No. 10-2023-0191728 filed in the Korean Intellectual Property Office on Dec. 26, 2023, the entire contents of which is incorporated herein by reference.

### TECHNICAL FIELD

The present disclosure relates to a multilayer ceramic capacitor and a manufacturing method thereof.

### BACKGROUND

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, as MLCCs become more highly integrated, they are becoming gradually thinner, and securing high reliability under thin-layer design is required.

### SUMMARY OF THE INVENTION

The present disclosure attempts to provide an excellent multilayer ceramic capacitor having improved DC-bias characteristics and reliability.

Another embodiment attempts to provide a method of preparing a multilayer ceramic capacitor.

A multilayer ceramic capacitor may include a capacitor body including a dielectric layer and an internal electrode layer, and an external electrode disposed outside the capacitor body, where the dielectric layer may include at least one dielectric grain, where the dielectric grain may include a barium titanate-based primary component including barium (Ba) and titanium (Ti), and a secondary component, where the secondary component may include samarium (Sm) as a first secondary component, and a second secondary component, where the second secondary component may include lanthanum (La), cerium (Ce), praseodymium (Pr), neodymium (Nd), promethium (Pm), europium (Eu), gadolinium (Gd), terbium (Tb), dysprosium (Dy), holmium (Ho), erbium (Er), thulium (Tm), ytterbium (Yb), lutetium (Lu), or a combination thereof, and where the second secondary component may be included in an amount ranging from 1.2 atom % to 2.0 atom % based on 100 atom % of titanium (Ti).

The second secondary component may include terbium (Tb), dysprosium (Dy), or a combination thereof.

The dielectric grain may include a core and a shell surrounding at least a portion of the core, the second secondary component may be included in the core and the shell, and an atom % of the second secondary component included in the shell may be higher than an atom % of the second secondary component included in the core.

An atomic ratio of the second secondary component included in the shell to the second secondary component included in the core may be in a range from 2 to 8.

Samarium (Sm) may be included in an amount ranging from 0.01 atom % to 1.2 atom % based on 100 atom % of titanium (Ti).

The dielectric grain may include core and a shell surrounding at least a portion of the core, samarium (Sm) may be included in the core and the shell, and an atom % of samarium (Sm) included in the shell may be higher than an atom % of samarium (Sm) included in the core.

An atomic ratio of samarium (Sm) included in the shell to samarium (Sm) included in the core may be in a range from 1.2 to 2.5.

The secondary component may further include a third secondary component including aluminum (Al), silicon (Si), magnesium (Mg), manganese (Mn), or a combination thereof.

The third secondary component may be included in an amount ranging from 0.1 atom % to 2.5 atom % based on 100 atom % of titanium (Ti).

The third secondary component may include aluminum (Al) and silicon (Si).

An atomic ratio of samarium (Sm) to a sum of aluminum (Al) and silicon (Si) may be in a range from 0.01 to 0.7.

A diameter of the dielectric grain may be in a range from 100 nm to 500 nm.

A manufacturing method of a multilayer ceramic capacitor may include preparing a dielectric slurry by mixing a barium titanate-based primary component powder and secondary component powder including a samarium (Sm)-containing compound and a second secondary component containing compound, manufacturing a dielectric green sheet by using the dielectric slurry, and forming a conductive paste layer on a surface of the dielectric green sheet, manufacturing a dielectric green sheet laminate by stacking the dielectric green sheet on which the conductive paste layer is formed, manufacturing a capacitor body including a dielectric layer and an internal electrode layer by firing the dielectric green sheet laminate, and forming an external electrode on a first surface of the capacitor body, where the second secondary component containing compound may include a lanthanum (La)-containing compound, a cerium (Ce)-containing compound, a praseodymium (Pr)-containing compound, a neodymium (Nd)-containing compound, a promethium (Pm)-containing compound, a europium (Eu)-containing compound, a gadolinium (Gd)-containing compound, a terbium (Tb)-containing compound, a dysprosium (Dy)-containing compound, a holmium (Ho)-containing compound, an erbium (Er)-containing compound, a thulium (Tm)-containing compound, a ytterbium (Yb)-containing compound, a lutetium (Lu)-containing compound, or a combination thereof, and where the second secondary component containing compound may be included in an amount ranging from 1.2 parts by mole to 2.0 parts by mole based on 100 parts by mole of the barium titanate-based primary component powder.

The second secondary component containing compound may include a terbium (Tb)-containing compound, a dysprosium (Dy)-containing compound, or a combination thereof.

The samarium (Sm)-containing compound may be included in an amount ranging from 0.01 parts by mole to 1.2 parts by mole based on 100 parts by mole of the barium titanate-based primary component powder.

The secondary component powder may further include a third secondary component containing compound including aluminum (Al)-containing compound, silicon (Si)-containing compound, magnesium (Mg)-containing compound, manganese (Mn)-containing compound, or a combination thereof.

The third secondary component containing compound may be included in an amount ranging from 0.1 parts by mole to 2.5 parts by mole based on 100 parts by mole of the barium titanate-based primary component powder.

The third secondary component containing compound may include the aluminum (Al)-containing compound and the silicon (Si)-containing compound.

A multilayer ceramic capacitor according to an embodiment may improve DC-bias characteristics and reliability.

### BRIEF DESCRIPTION OF THE DRAWINGS

FIG. 1 is a perspective view showing a multilayer ceramic capacitor according to an embodiment.

FIG. 2 is a cross-sectional view of a multilayer ceramic capacitor taken along line I-I′ of FIG. 1.

FIG. 3 is a cross-sectional view of a multilayer ceramic capacitor taken along line II-II′ of FIG. 1.

FIG. 4 is a low-magnification TEM image of a dielectric layer according to Example 1.

FIG. 5 is an EDS line analysis diagram with respect to the dielectric grain illustrated in FIG. 4.

FIG. 6 is a high-magnification TEM image of a dielectric layer according to Example 1.

FIG. 7 is a graph showing the high-temperature severity reliability of a multilayer ceramic capacitor according to Comparative Example 1.

FIG. 8 is a graph showing the high-temperature severity reliability of a multilayer ceramic capacitor according to Example 3.

FIG. 9 is a graph showing the high-temperature severity reliability of a multilayer ceramic capacitor according to Example 5.

### DETAILED DESCRIPTION OF THE EMBODIMENTS

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

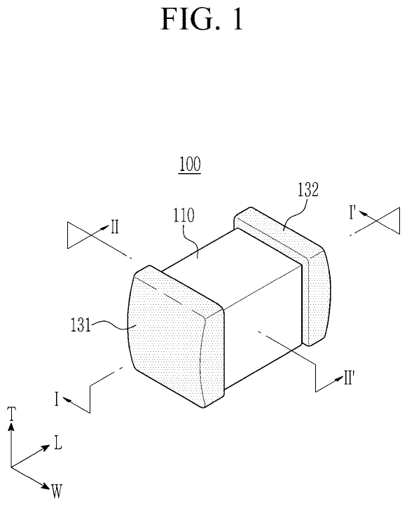

Hereinafter, a multilayer ceramic capacitor according to an embodiment will be described with reference to FIG. 1 to FIG. 3.

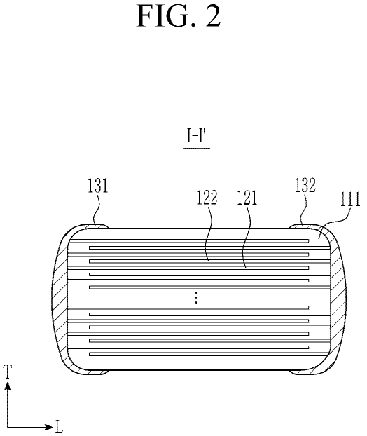

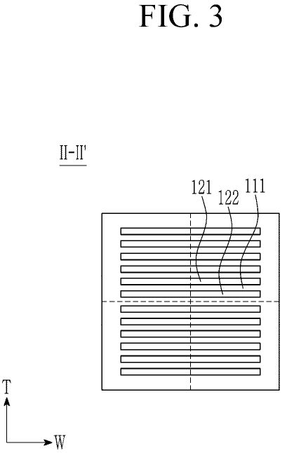

FIG. 1 is a perspective view showing a multilayer ceramic capacitor according to an embodiment. FIG. 2 is a cross-sectional view of a multilayer ceramic capacitor taken along line I-I′ of FIG. 1. FIG. 3 is a cross-sectional view of a multilayer ceramic capacitor taken along line II-II′ of FIG. 1.

The L-axis, W-axis, and T-axis shown in FIG. 1 to FIG. 3 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIG. 1 to FIG. 3, a multilayer ceramic capacitor 100 according to an embodiment includes the capacitor body 110 and external electrodes 131 and 132 disposed outside the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode 121 and a second internal electrode 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may have the active region. The active region is a region where the dielectric layer 111 and the internal electrode layers 121 and 122 are alternately disposed, which contributes to forming capacity of the multilayer ceramic capacitor 100. Specifically, the active region may be a region where the first internal electrode 121 or the second internal electrode 122 stacked along the thickness direction (T-axis direction) overlap.

In addition, the capacitor body 110 may further include a cover portion and a side marginal portion.

The cover region is a thickness direction marginal portion, and may be positioned on the first and second surfaces of the active region in the thickness direction (T-axis direction), respectively. This cover portion may be a single dielectric layer 111 or two or more dielectric layers 111 stacked on the upper and lower surfaces of the active region, respectively.

The side marginal portion may be considered as a side cover portion, and may be located at each of both ends of the active region facing each other in the width direction (the W-axis direction), i.e., to the fifth surface and the sixth surface. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover region and the side marginal portion serve to prevent damage to the first internal electrode 121 and the second internal electrode 122 due to physical or chemical stress.

The dielectric layer 111 may include at least one dielectric grain.

The dielectric grain may include a barium titanate-based primary component including barium (Ba) and titanium (Ti), and a secondary component.

The barium titanate-based primary component is a dielectric base material, has a high dielectric constant, and contributes to forming the dielectric constant of the multilayer ceramic capacitor 100.

The barium titanate-based primary component may include, for example, BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

The secondary component may include a first secondary component and a second secondary component. The first secondary component may be samarium (Sm), and the second secondary component may a lanthanum-based element other than samarium (Sm). That is, the second secondary component may include lanthanum (La), cerium (Ce), praseodymium (Pr), neodymium (Nd), promethium (Pm), europium (Eu), gadolinium (Gd), terbium (Tb), dysprosium (Dy), holmium (Ho), erbium (Er), thulium (Tm), ytterbium (Yb), lutetium (Lu), or a combination thereof.

For example, since Sm³⁺ has a larger ion radius than Dy³⁺, to have greater replacement efficiency as an A-site donor, free electron emission effect is increased, and defect concentration control effect is excellent. In addition, compared to barium titanate doped with Dy, sufficient grain growth may occur in the case of barium titanate doped with Sm, enabling implementation of high capacity. Therefore, according to an embodiment, by including samarium (Sm) as the first secondary component in the dielectric grain, a multilayer ceramic capacitor having improved DC-bias characteristics and reliability may be secured. Here, improvement in DC-bias characteristics means improvement in DC effective capacity, which means that the degree to which capacity decreases when a DC voltage is applied is reduced.

In addition, according to an embodiment, since another lanthanum-based element as the second secondary component together with samarium (Sm) as the first secondary component is included the dielectric grain, the DC-bias characteristics and reliability of a multilayer ceramic capacitor may be further improved.

Samarium (Sm) may be included in the dielectric grain in an amount ranging from 0.01 atom % to 1.2 atom % based on 100 atom % of titanium (Ti), and for example, may be included in a range from 0.05 atom % to 1.1 atom %, or 0.1 atom % to 1.0 atom %. When samarium (Sm) is included in the dielectric grain in the above content range, a multilayer ceramic capacitor having an excellent DC-bias characteristics and reliability may be secured.

The dielectric grain may have a core-shell structure that includes a core and a shell surrounding at least a portion of the core. Samarium (Sm) may be included in both the core and the shell, and the atom % of samarium (Sm) included in the shell may be higher than the atom % of samarium (Sm) included in the core. Specifically, an atomic ratio of samarium (Sm) included in the shell compared to samarium (Sm) included in the core may be in an range from 1.2 to 2.5, and may be, for example, in a range from 1.3 to 2.2, or 1.5 to 2.0. When the atom % of samarium (Sm) is higher in the shell than in the core, specifically, when the atomic ratio of the above range is satisfied, the DC-bias characteristics and reliability of a multilayer ceramic capacitor may be improved.

The second secondary component may include, for example, terbium (Tb), dysprosium (Dy), or a combination thereof, among above-described lanthanum-based elements.

The second secondary component may be included in the dielectric grain in an amount ranging from 1.2 atom % to 2.0 atom % based on 100 atom % of titanium (Ti), and for example, may be included in a range from 1.3 atom % to 1.9 atom %, or 1.4 atom % to 1.8 atom %. When the second secondary component includes two or more types of elements, the content of the second secondary component means a total content of respective elements.

When the second secondary component is included in the dielectric grain within the above content range, a multilayer ceramic capacitor having an excellent DC-bias characteristics and reliability may be secured.

The second secondary component may also be all included in the core and the shell, and the atom % of the second secondary component included in the shell may be higher than the atom % of the second secondary component included in the core. Specifically, an atomic ratio of the second secondary component included in the shell to the second secondary component included in the core may be in a range from 2 to 8, and may be, for example, in a range from 3 to 7, or 4 to 6. When the atom % of the second secondary component is higher in the shell than in the core, specifically, when the atomic ratio of the above range is satisfied, the DC-bias characteristics and reliability of a multilayer ceramic capacitor may be improved.

The secondary component may further include a third secondary component. The third secondary component may include aluminum (Al), silicon (Si), magnesium (Mg), manganese (Mn), or a combination thereof. When the third secondary component is included in the dielectric grain together with samarium (Sm) as the first secondary component and another lanthanum-based element as the second secondary component, the DC-bias characteristics and reliability of a multilayer ceramic capacitor may be further improved.

The third secondary component may be included in the dielectric grain in an amount ranging from 0.1 atom % to 2.5 atom % based on 100 atom % of titanium (Ti), and for example, may be included in a range from 1.0 atom % to 2.5 atom %, or 1.4 atom % to 2.5 atom %. When the third secondary component is included in the dielectric grain within the above content range, a multilayer ceramic capacitor having an excellent DC-bias characteristics and reliability may be secured.

The third secondary component may include, as an example, aluminum (Al) and silicon (Si). In this case, an atomic ratio of samarium (Sm) to a sum of aluminum (Al) and silicon (Si) may be in a range from 0.01 to 0.7, and may be, for example, in a range from 0.05 to 0.7, or 0.1 to 0.7. When the atomic ratio of the above range is satisfied, the DC-bias characteristics and reliability of a multilayer ceramic capacitor may be improved.

Confirmation of samarium (Sm) as the first secondary component, another lanthanum-based element as the second secondary component, and optionally selectively the third secondary component, which are included in the dielectric grain and contents thereof may be obtained by a transmission electron microscope-energy dispersive spectroscopy (TEM-EDS) analysis.

In more detail, after the multilayer ceramic capacitor 100 was placed into the epoxy mixture liquid and then cured, the W-axis and the T-axis directional surface (WT surface) of the capacitor body 110 was polished to 1/2 depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Subsequently, the active region of the cross-sectional sample may be measured by the transmission electron microscope (TEM). For example, TEM may be measured in a region of about 400 nm×400 nm where at least one layer of the dielectric layer 111 may be seen in the active region by using focused ion beam (Xe-FIB) under the condition of acceleration voltage of 200 kV. Subsequently, in the TEM image of the measured cross-sectional sample, by perform the EDS analysis with respect to points in at least one dielectric grain within one dielectric layer, for example, respective points within one to ten, two to five dielectric grains, contents of elements and an arithmetic average value may be obtained. Specifically, by performing the EDS analysis with respect to points in each core and shell of at least one dielectric grain having core-shell structure, for example, points in each core and shell of one to ten, two to five dielectric grain having core-shell structure, contents of elements and the arithmetic average value in each of the core and the shell may be obtained.

The diameter of the dielectric grain may be in a range from 100 nm to 500 nm based on the longest axis, and may be, for example, in a range from 200 nm to 400 nm. When the diameter of the dielectric grain is within the above range, excellent insulation resistance (IR) may be maintained while implementing high-capacity, and accordingly, a multilayer ceramic capacitor having excellent reliability may be secured.

An average thickness (average length in the T-axis direction) of the dielectric layer 111 may be in a range from 2.0 μm to 8.0 μm, and for example, may be in a range from 0.1 μm to 4.0 μm. When the average thickness of the dielectric layer 111 is within the above range, the reliability of the multilayer ceramic capacitor is excellent.

The average thickness of the dielectric layer 111 may be measured by a scanning electron microscope (SEM) analysis, by placing the multilayer ceramic capacitor 100 into the epoxy mixture liquid and then curing, polishing, and ion milling it. The scanning electron microscope may use, for example, a Verios G4 product from Thermofisher Scientific, the measure condition may be 10 kV, 0.2 nA, the analysis magnification may be 100 times, and the measurement may be made such that at least 1 layer or more, 3 layers or more, 5 layers or more, or 10 layers or more of the dielectric layer 111 may be obtained. In the scanning electron microscope (SEM) image, the central point of the dielectric layer 111 in the length direction (L-axis direction) or the width direction (W-axis direction) is taken as a reference point, and an arithmetic average value of the thicknesses of the dielectric layer 111 may be obtained for 10 points disposed apart from the reference point by a predetermined interval. The intervals of the 10 points may be adjusted depending on the scale of the SEM image, and may be, for example, 1 μm to 100 μm, 1 um to 50 μm, or 1 μm to 10 μm. At this time, all 10 points must be positioned within the dielectric layer 111, and if all 10 points are not positioned within the dielectric layer 111, the position of the reference point may be changed, or the interval between the 10 points may be adjusted.

The first internal electrode 121 and the second internal electrode 122 are electrodes having different polarities, alternately disposed interposing the dielectric layer 111 to face each other along the T-axis direction, and may have a first end exposed through the third and fourth surfaces of the capacitor body 110, respectively.

The first internal electrode 121 and the second internal electrode 122 may be electrically insulated from each other by the dielectric layer 111 disposed in the middle.

End portions of the first internal electrode 121 and the second internal electrode 122 alternately exposed through the third and fourth surfaces of the capacitor body 110 may be electrically connected to the first external electrode 131 and the second external electrode 132, respectively.

The first internal electrode 121 and the second internal electrode 122 may include a conductive metal, for example, a metal such as Ni, Cu, Ag, Pd, Au, or an alloy thereof, such as an Ag—Pd alloy.

Additionally, the first internal electrode 121 and the second internal electrode 122 may include dielectric particles of the same composition as the ceramic material included in the dielectric layer 111.

The first internal electrode 121 and the second internal electrode 122 may be formed using a conductive paste including a conductive metal. The printing method of the conductive paste may be a screen printing method or a gravure printing method.

The average thickness of the first internal electrode 121 and the second internal electrode 122 may be in a range from 0.1 μm to 2 μm. The average thickness of the first internal electrode 121 and the second internal electrode 122 may be measured by the SEM analysis. Here, since the SEM analysis is the same as the method for measuring the average thickness of the dielectric layer 111 described above, a description thereof will be omitted.

The capacitor body 110 may be formed by firing a stacking structure in which the plurality of dielectric layers 111 and internal electrode layers 121 and 122 are stacked.

The first external electrode 131 and the second external electrode 132 provide voltages of different polarities, and may be electrically connected to exposed portions of the first internal electrode 121 and the second internal electrode 122, respectively.

According to the above configuration, when a predetermined voltage is applied to the first external electrode 131 and the second external electrode 132, charges are accumulated between the first internal electrode 121 and the second internal electrode 122 facing each other. At this time, the capacitance of the multilayer ceramic capacitor 100 is proportional to the overlapping area of the first internal electrode 121 and the second internal electrode 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode 121 and the second internal electrode 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

Each of the first external electrode 131 and the second external electrode 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include copper (Cu), nickel (Ni), silver (Ag), palladium (Pd), gold (Au), platinum (Pt), tin (Sn), tungsten (W), titanium (Ti), lead (Pb), an alloy thereof, or a combination thereof, and for example, the term copper (Cu) may include a copper (Cu) alloy. When the conductive metal includes copper (Cu), metals other than copper (Cu) may be included in an amount of 5 parts by mole or less with respect to 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include phenolic resin, acrylic resin, silicone resin, epoxy resin, or polyimide resin.

The conductive metal included in the conductive resin layer serves to be electrically connected to the first internal electrode 121 and the second internal electrode 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is 1.45 or less. Flake shape powder refers to a powder with a flat and elongated shape, and is not particularly limited. But for example, the length ratio of the major axis and the minor axis (major axis/minor axis) may be 1.95 or more.

The first external electrode 131 and the second external electrode 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer capacitor 100.

Hereinafter, a method of preparing the multilayer ceramic capacitor 100 according to an embodiment will be described.

The multilayer ceramic capacitor 100 according to an embodiment may be manufactured through the steps of preparing a dielectric slurry by mixing a barium titanate-based primary component powder and secondary component powder comprising a samarium (Sm)-containing compound and a second secondary component containing compound, manufacturing a dielectric green sheet by using the dielectric slurry, and forming a conductive paste layer on a surface of the dielectric green sheet, manufacturing a dielectric green sheet laminate by stacking the dielectric green sheet in which the conductive paste layer is formed, manufacturing a capacitor body comprising a dielectric layer and an internal electrode layer by firing the dielectric green sheet laminate, and forming an external electrode on a first surface of the capacitor body,

First, the dielectric slurry is prepared by mixing the barium titanate-based primary component powder and the secondary component powder.

The barium titanate-based primary component powder may be prepared by mixing titanium (Ti) precursor and barium (Ba) precursor.

The titanium (Ti) precursor may be oxide, salt, alkoxide, or the like of titanium, and may include, for example, titanium dioxide, titanium diisopropoxide diacetyl acetonate (TPA), titanium alkoxide, or a combination thereof. Barium (Ba) precursor may include BaO₂, BaTiO₃, BaCO₃, BaO, or a combination thereof.

The barium (Ba) precursor may be included in an amount ranging from 0.9 moles to 1.1 moles based on 1 mole of the titanium (Ti) precursor.

The secondary component powder may a include samarium (Sm)-containing compound and the second secondary component containing compound.

The samarium (Sm)-containing compound may be an oxide, a nitride or a salt compound, and/or may be used in the form of a sol dispersed in an organic solvent.

The samarium (Sm)-containing compound may be mixed in an amount ranging from 0.01 parts by mole to 1.2 parts by mole based on 100 parts by mole of the barium titanate-based primary component powder, and for example, may be mixed in an amount ranging from 0.1 parts by mole to 1.0 parts by mole. When the samarium (Sm)-containing compound is mixed within the above content range, the DC-bias characteristics and reliability of a multilayer ceramic capacitor may be improved.

The second secondary component containing compound may include a lanthanum (La)-containing compound, a cerium (Ce)-containing compound, a praseodymium (Pr)-containing compound, a neodymium (Nd)-containing compound, a promethium (Pm)-containing compound, a europium (Eu)-containing compound, a gadolinium (Gd)-containing compound, a terbium (Tb)-containing compound, a dysprosium (Dy)-containing compound, a holmium (Ho)-containing compound, an erbium (Er)-containing compound, a thulium (Tm)-containing compound, a ytterbium (Yb)-containing compound, a lutetium (Lu)-containing compound, or a combination thereof. The second secondary component containing compound may include, as an example, a terbium (Tb)-containing compound, a dysprosium (Dy)-containing compound, or a combination thereof.

The second secondary component containing compound may be an oxide, a nitride or a salt compound, and/or may be used in the form of a sol dispersed in an organic solvent.

The second secondary component containing compound may be mixed in an amount ranging from 1.2 parts by mole to 2.0 parts by mole based on 100 parts by mole of the barium titanate-based primary component powder, and for example, may be mixed in an amount ranging from 1.4 parts by mole to 1.8 parts by mole. When the second secondary component containing compound is mixed within the above content range, the DC-bias characteristics and reliability of a multilayer ceramic capacitor may be improved.

The secondary component powder may further include the third secondary component containing compound.

The third secondary component containing compound may include aluminum (Al)-containing compound, silicon (Si)-containing compound, magnesium (Mg)-containing compound, manganese (Mn)-containing compound, or a combination thereof. The third secondary component containing compound may include, as an example, aluminum (Al)-containing compound and silicon (Si)-containing compound.

The third secondary component containing compound may be an oxide, a nitride or a salt compound, and or may be used in the form of a sol dispersed in an organic solvent.

The third secondary component containing compound may be mixed in an amount ranging from 0.1 parts by mole to 2.5 parts by mole based on 100 parts by mole of the barium titanate-based primary component powder, and for example, may be mixed in an amount ranging from 1.4 parts by mole to 2.5 parts by mole. When the third secondary component containing compound is mixed within the above content range, the DC-bias characteristics and reliability of a multilayer ceramic capacitor may be improved.

The dielectric slurry may be prepared by additionally mixing solvents and additives, such as dispersants, binders, plasticizers, lubricants, antistatic agents, in addition to the obtained dielectric material powder.

The dispersant may include, for example, phosphoric acid ester-based dispersant, polycarboxylic acid-based dispersant or a combination thereof. The dispersant may be mixed in an amount ranging from 0.1 part by weight to 5 parts by weight based on 100 parts by weight of the barium titanate-based primary component powder, and for example, may be mixed in an amount ranging from 0.3 parts by weight to 3 parts by weight. When the dispersant is mixed within the above content range, the dielectric slurry shows excellent dispersibility, and the amount of impurities included in the manufactured dielectric layer may be reduce.

The binder may be, for example, acryl resin, polyvinyl butyl resin, polyvinyl acetal resin, ethylcellulose resin, or the like. The binder may be added in an amount of 0.1 part by weight to 50 parts by weight, for example, in an amount of 3 parts by weight to 30 parts by weight, based on 100 parts by weight of the barium titanate-based primary component powder. When the binder is mixed within the above content range, the dielectric slurry shows excellent dispersibility, and the amount of impurities included in the manufactured dielectric layer may be reduce.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount ranging from 0.1 part by weight to 20 parts by weight, for example, in an amount of 1 part by weight to 10 parts by weight, based on 100 parts by weight of the barium titanate-based primary component powder. When the plasticizer is mixed within the above content range, the dielectric slurry shows excellent dispersibility, and the amount of impurities included in the manufactured dielectric layer may be reduce.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering dissolubility or dispersibility of various additives included in the dielectric slurry. The solvent may be mixed in an amount ranging from 50 parts by weight to 1000 parts by weight based on 100 parts by weight of the barium titanate-based primary component powder, and for example, may be mixed in an amount ranging from 100 parts by weight to 500 parts by weight. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter ranging from 0.1 mm to 10 mm may be used for wet mixing for a period in a range from 8 hours to 48 hours, or 10 hours to 24 hours.

The prepared the dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

To form the conductive paste layer that becomes the internal electrode layer after firing, a conductive paste may be prepared by mixing a conductive powder made of a conductive metal or an alloy thereof, a binder, and a solvent. Additionally, barium titanate powder may be mixed together as a co-material if necessary. The co-material may act to suppress sintering of the conductive powder during the firing process. The conductive paste layer is formed by applying a conductive paste to the surface of the dielectric green sheet in a predetermined pattern using various printing methods such as screen printing or transfer methods.

The conductive powder may include nickel (Ni) or a nickel (Ni) alloy.

Next, a dielectric green sheet laminate is prepared by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet laminate in the stacking direction.

The step of cutting the prepared dielectric green sheet laminate to a predetermined size by dicing or the like may optionally be performed.

Additionally, the dielectric green sheet laminate may be solidified and dried to remove plasticizers, etc., if necessary, and after solidified and dried, the dielectric green sheet laminate may be barrel polished using a horizontal centrifugal barrel machine, and the like. In barrel polishing, the dielectric green sheet laminate is placed into a barrel container with media and polishing liquid, and rotational motion or vibration is applied to the barrel container, thus unnecessary parts, such as burrs generated during cutting, may be polished. Additionally, after barrel polishing, the dielectric green sheet laminate may be washed with a cleaning solution such as water, and dried.

Subsequently, the capacitor body may be prepared after binder removal treatment and firing of the dielectric green sheet laminate.

The conditions for binder removal may be appropriately adjusted depending on the components of the dielectric layer or the internal electrode layer. For example, the rate of temperature rise during binder removal treatment may be in a range from 5° C./hour to 300° C./hour, the support temperature may be in a range from 180° C. to 400° C., and the temperature holding time may be in a range from 0.5 hour to 24 hours. The binder removal may be performed under an air atmosphere or a reducing atmosphere.

The conditions of the firing treatment may be appropriately adjusted depending on the primary component composition of the dielectric layer or the primary component composition of the internal electrode. For example, firing may be performed at a temperature in a range from 1100° C. to 1400° C., and may be performed at a temperature in a range from 1200° C. to 1350° C. Additionally, firing may be performed for a period in a range from 0.5 to 8 hours, for example, 1 to 3 hours. Additionally, firing may be performed in a reducing atmosphere, for example, in a humidified mixed gas of nitrogen and hydrogen. When the internal electrode includes nickel (Ni) or a nickel (Ni) alloy, an oxygen partial pressure under the firing atmosphere may be in a range from 1.0×10⁻¹⁴ MPa to 1.0×10⁻¹⁰ MPa.

After firing, annealing may be performed as needed. Annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be in a range from 950° C. to 1150° C., the time may be in a range from 0 to 20 hours, and the rate of temperature rise may be in a range from 50° C./hour to 500° C./hour. The annealing atmosphere may be a humidified nitrogen gas (N₂) atmosphere, and an oxygen partial pressure may be in a range from 1.0×10⁻⁹ MPa to 1.0×10⁻⁵ MPa.

In binder removal treatment, firing treatment, or annealing treatment, for example, a wetter may be used to humidify nitrogen gas or mixed gas. In this case, the water temperature may be in a range from 5° C. to 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode and the second internal electrode may be exposed to the outermost surfaces of the third and fourth surfaces, and thus the electrical connection between the first external electrode and the second external electrode, and the first internal electrode and the second internal electrode may be improved, alloy portions may be easily formed.

Subsequently, the external electrode is formed on the first surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the conductive resin layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature in a range from 700° C. to 1000° C. for a period in a range from 0.1 hour to 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, solvent, dispersant, plasticizer, oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen printing method or a gravure printing method, or by applying the paste for forming the conductive resin layer to the surface of the capacitor body 110 and then curing it.

Next, the plating layer is formed on the outside of the conductive resin layer.

For example, the plating layer may be formed by a plating method, sputtering, or electrolytic plating (electric deposition).

The above-described embodiments will be described in more detail through Examples below. However, the following examples are for illustrative purposes only and do not limit the scope of appended claims.

### Manufacturing of Multilayer Ceramic Capacitor

### Examples 1 to 8 and Comparative Examples 1 to 7

The dielectric slurry was prepared by mixing the barium titanate (BaTiO₃) as the primary component powder, and samarium oxide (Sm₂O₃), dysprosium oxide (Dy₂O₃), terbium oxide (Tb₄O₇), aluminum oxide (Al₂O₃), and silicon dioxide (SiO₂) as the secondary component powder according to the composition of Table 1 below. Mixing was performed by using zirconia ball (ZrO₂ ball) as a dispersion medium, in which ethanol/toluene and polyvinyl butyral (PVB) resin as a wetting dispersant and binder was added together and mechanical milling was performed.

The dielectric slurry was prepared by mixing the prepared dielectric material powder. Mixing was performed by using zirconia ball (ZrO₂ ball) as a dispersion medium, in which ethanol/toluene and polyvinyl butyral (PVB) resin as a wetting dispersant and binder was added together and mechanical milling was performed.

The dielectric green sheet was prepared by using a head discharge type on-roll forming coater on the prepared dielectric slurry.

A conductive paste layer including nickel (Ni) was printed on the surface of the dielectric green sheet, and the dielectric green sheet on which the conductive paste layer is formed was stacked and squeezed, to prepare a dielectric green sheet laminate.

The dielectric green sheet laminate was subjected to a plasticizing process at 400° C. or lower in a nitrogen atmosphere, and then fired at a firing temperature of 1300° C. or lower and a hydrogen concentration of 1.0% H₂ or lower.

Subsequently, a multilayer ceramic capacitor was manufactured through processes of an external electrode, plating, or the like.

### Table 1

The unit of content of each component is parts by mole expressed based on 100 parts by mole of the primary component powder of barium titanate (BaTiO₃).

| | | | | Sm₂O₃/ |
|---|---|---|---|---|
| | Sm₂O₃ | Dy₂O₃ | Tb₄O₇ | (Al₂O₃ + SiO₂) |
| Example 1 | 0.2 | 1 | 0.3 | 0.1 |
| Example 2 | 0.2 | 1.5 | 0.5 | 0.1 |
| Example 3 | 0.4 | 1 | 0.3 | 0.3 |
| Example 4 | 0.4 | 1.5 | 0.5 | 0.3 |
| Example 5 | 0.8 | 1 | 0.3 | 0.5 |
| Example 6 | 0.8 | 1.5 | 0.5 | 0.5 |
| Example 7 | 1.2 | 1 | 0.3 | 0.7 |
| Example 8 | 1.2 | 1.5 | 0.5 | 0.7 |
| Comparative | 0 | 1 | 0.3 | 0 |
| Example 1 | | | | |
| Comparative | 0 | 1.5 | 0.5 | 0 |
| Example 2 | | | | |
| Comparative | 0 | 1 | 0.5 | 0 |
| Example 3 | | | | |
| Comparative | 0.2 | 0.7 | 0.3 | 0.1 |
| Example 4 | | | | |
| Comparative | 0.4 | 0.7 | 0.3 | 0.3 |
| Example 5 | | | | |
| Comparative | 0.8 | 0.7 | 0.3 | 0.5 |
| Example 6 | | | | |
| Comparative | 1.2 | 0.7 | 0.3 | 0.7 |
| Example 7 | | | | |

### Evaluation 1: TEM-EDS Analysis

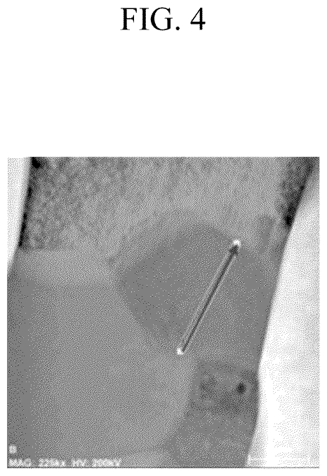

The transmission electron microscope-energy dispersive spectroscopy (TEM-EDS) analysis was performed with respect to the multilayer ceramic capacitors manufactured in Examples 1 to 8 and Comparative Examples 1 to 7, and the results were shown in Table 2 and Table 3 below and FIG. 4 to FIG. 6.

TEM-EDS analysis was measured as follows. The cross-section sample was obtained such that the active region where the dielectric layer and the internal electrode layer intersect may be observed, as the multilayer ceramic capacitors manufactured in Examples 1 to 8 and Comparative Examples 1 to 7 were placed into an epoxy mixture liquid and cured, the W-axis and T-axis direction surface (WT surface) of the capacitor body 110 is polished to a depth of 1/2 in the L-axis direction, and then it was fixed and maintained in a vacuum atmosphere chamber. The active region of the cross-section sample was measured by using TEM. TEM was measured in a region of about 400 nm×400 nm where at least one layer of the dielectric layer 111 may be seen in the active region by using focused ion beam (Xe-FIB) under the condition of acceleration voltage of 200 kV.

In the TEM image of the measured cross-sectional sample, contents of Sm, Dy, and Tb existing in the dielectric grain was confirmed by an EDS line analysis. Specifically, as shown in FIG. 4, the atom % of each component was confirmed for the line section connected by a straight line from the start point to the end point of the dielectric grain.

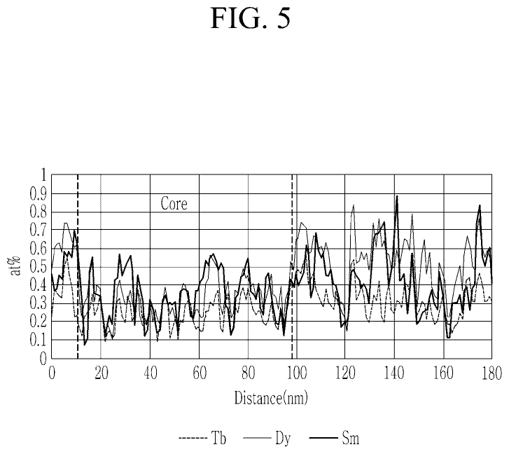

FIG. 4 is a low-magnification TEM image of a dielectric layer according to Example 1. FIG. 5 is an EDS line analysis diagram with respect to the dielectric grain illustrated in FIG. 4.

Referring to FIG. 5, Sm, relative atom % of Dy and Tb may be confirmed, and it may be seen that the concentration of samarium (Sm) tends to increase in the region of the shell compared to the core.

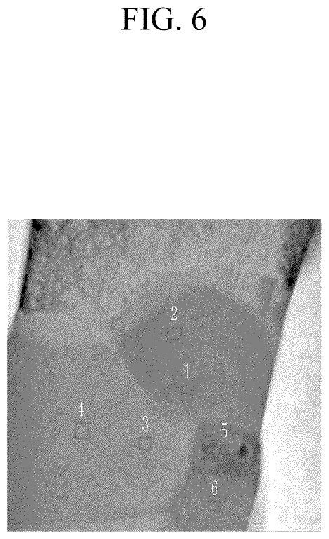

FIG. 6 is a high-magnification TEM image of a dielectric layer according to Example 1.

In addition, in the transmission electron microscope (TEM) image of the measured cross-sectional sample of Example 1, as shown in FIG. 6, the EDS analysis was performed at points in the core and the shell in each the dielectric grain, with respect to three dielectric grains within one dielectric layer. By the EDS analysis, an arithmetic average value of atom % of O, Ti, Dy, and Sm components at three core points and an arithmetic average value of atom % of O, Ti, Dy, and Sm component at three shell points are obtained, and the results are shown in Table 2 below.

### Table 2

The unit is atom % based on the total amount of elements at each point.

| | | | | | Average |
|---|---|---|---|---|---|
| | Element | Point 1 | Point 3 | Point 5 | value |
| Core | O | 50.32 | 48.99 | 51.18 | 50.16 |
| | Ti | 22.71 | 22.6 | 22.02 | 22.44 |
| | Dy | 0 | 0.16 | 0.02 | 0.06 |
| | Sm | 0.14 | 0.19 | 0.19 | 0.17 |
| | | | | | Average |
| | Element | Point 2 | Point 4 | Point 6 | value |
| Shell | O | 49.6 | 48.12 | 49.2 | 48.97 |
| | Ti | 22.85 | 22.68 | 21.88 | 22.47 |
| | Dy | 0.31 | 0.31 | 0.29 | 0.3 |
| | Sm | 0.31 | 0.2 | 0.45 | 0.32 |

Through Table 2, it may be seen that, in Example 1, samarium (Sm) and dysprosium (Dy) have higher atom %, i.e., higher concentration, in the region of the shell compared to the core.

### Evaluation 2: Reliability

The dielectric constant, MTTF, and insulation resistance (IR) level were measured with respect to the multilayer ceramic capacitors manufactured in Examples 1 to 8 and Comparative Examples 1 to 7, and the results were shown in Table 3 below.

The dielectric constant was measured under the condition of 1 KHz and 0.5 V.

The mean time to failure (MTTF) was measured under the condition of a temperature 125° C. and voltage 9.45 V to obtain a mean time to failure (hr) at which fail occurs. In Table 3 below, ◯ indicates an average failure time of 11 hours or more, and X indicates an average failure time of less than 11 hours.

Insulation resistance (IR) level may be obtained while measuring the high-temperature severity reliability (HALT) under the condition of 125° C., 9.45 V, and 0 hours, by using an ESPEC (PV-222, HALT) equipment.

### Table 3

The unit of content of each component is atom % based on 100 atom % of titanium (Ti).

| | Sm | Dy | Tb | Sm/ | Dielectric | | IR |
|---|---|---|---|---|---|---|---|
| | (atom %) | (atom %) | (atom %) | (Al + Si) | constant | MTTF | level |
| Example 1 | 0.2 | 1 | 0.3 | 0.1 | 2100 | ◯ | 10\hat{\hat{ }}6 |
| Example 2 | 0.2 | 1.5 | 0.5 | 0.1 | 2200 | ◯ | 10\hat{ }6 |
| Example 3 | 0.4 | 1 | 0.3 | 0.3 | 2400 | ◯ | 10\hat{ }6 |
| Example 4 | 0.4 | 1.5 | 0.5 | 0.3 | 2500 | ◯ | 10\hat{ }6 |
| Example 5 | 0.8 | 1 | 0.3 | 0.5 | 2700 | ◯ | 10\hat{ }5 |
| Example 6 | 0.8 | 1.5 | 0.5 | 0.5 | 2900 | ◯ | 10\hat{ }5 |
| Example 7 | 1.2 | 1 | 0.3 | 0.7 | 2900 | ◯ | 10\hat{ }6 |
| Example 8 | 1.2 | 1.5 | 0.5 | 0.7 | 3100 | ◯ | 10\hat{ }6 |
| Comparative | 0 | 1 | 0.3 | 0 | 1800 | X | 10\hat{ }6 |
| Example 1 | | | | | | | |
| Comparative | 0 | 1.5 | 0.5 | 0 | 2000 | X | 10\hat{ }7 |
| Example 2 | | | | | | | |
| Comparative | 0 | 1 | 0.5 | 0 | 2100 | X | 10\hat{ }7 |
| Example 3 | | | | | | | |
| Comparative | 0.2 | 0.7 | 0.3 | 0.1 | 2000 | X | 10\hat{ }6 |
| Example 4 | | | | | | | |
| Comparative | 0.4 | 0.7 | 0.3 | 0.3 | 2100 | X | 10\hat{ }6 |
| Example 5 | | | | | | | |
| Comparative | 0.8 | 0.7 | 0.3 | 0.5 | 2500 | X | 10\hat{ }5 |
| Example 6 | | | | | | | |
| Comparative | 1.2 | 0.7 | 0.3 | 0.7 | 2700 | X | 10\hat{ }5 |
| Example 7 | | | | | | | |

Through Table 3, it may be seen that, in Examples 1 to 8 in which samarium (Sm), and the second secondary component such as dysprosium (Dy) and terbium (Tb) are included in the dielectric grain according to an embodiment and all of the second secondary components satisfies the predetermined ranges of atom %, the dielectric constant, MTTF, and insulation resistance (IR) level are all excellent compared to Comparative Examples 1 to 7.

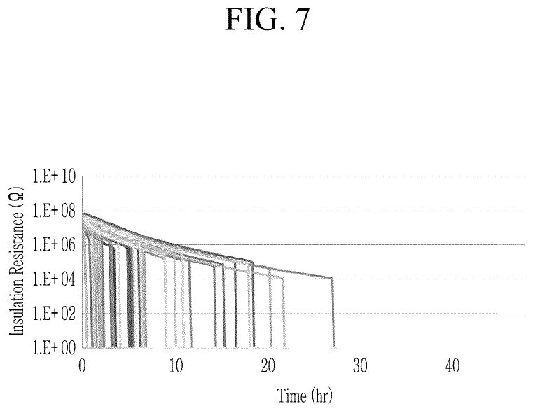

In addition, the multilayer ceramic capacitors manufactured in Examples 3 and 5 and Comparative Example 1 were prepared as sets of 40 items and mounted on a measurement substrate, the high-temperature severity reliability (HALT) was measured under the condition of 125° C., 9.45 V, and 48 hours by using ESPEC (PV-222, HALT) equipment, and the results were shown in FIG. 7 to FIG. 9.

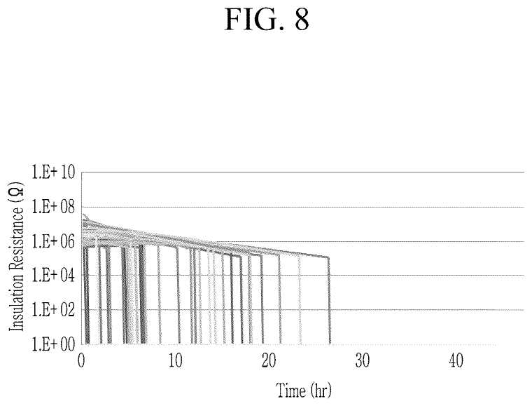

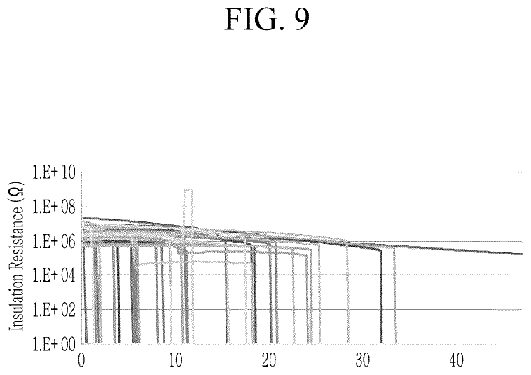

FIG. 7 is a graph showing the high-temperature severity reliability of a multilayer ceramic capacitor according to Comparative Example 1. FIG. 8 is a graph showing the high-temperature severity reliability of a multilayer ceramic capacitor according to Example 3. FIG. 9 is a graph showing the high-temperature severity reliability of a multilayer ceramic capacitor according to Example 5.

Referring to FIGS. 7 to FIG. 9, it may be seen that Examples 3 and 5 in which samarium (Sm), and the second secondary component such as dysprosium (Dy) and terbium (Tb) are included in the dielectric grain according to an embodiment and all of the second secondary components have the predetermined range of atom % may provide excellent high-temperature severity reliability compared to Comparative Example 1.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: multilayer ceramic capacitor
110: capacitor body
111: dielectric layer
121: first internal electrode
122: second internal electrode
131: first external electrode
132: second external electrode

What is claimed is:

1. A multilayer ceramic capacitor, comprising:
a capacitor body comprising a dielectric layer and an internal electrode layer; and
an external electrode disposed outside the capacitor body,
wherein the dielectric layer comprises at least one dielectric grain,
wherein the dielectric grain comprises a barium titanate-based primary component comprising barium (Ba) and titanium (Ti), and a secondary component,
wherein the secondary component comprises samarium (Sm) as a first secondary component, and a second secondary component comprising lanthanum (La), cerium (Ce), praseodymium (Pr), neodymium (Nd), promethium (Pm), europium (Eu), gadolinium (Gd), terbium (Tb), dysprosium (Dy), holmium (Ho), erbium (Er), thulium (Tm), ytterbium (Yb), lutetium (Lu), or a combination thereof, and
wherein the second secondary component is comprised in an amount ranging from 1.2 atom % to 2.0 atom % based on 100 atom % of titanium (Ti).

2. The multilayer ceramic capacitor of claim 1, wherein the second secondary component comprises terbium (Tb), dysprosium (Dy), or a combination thereof.

3. The multilayer ceramic capacitor of claim 1, wherein:
the dielectric grain comprises a core and a shell surrounding at least a portion of the core;
the second secondary component is comprised in the core and the shell; and
an atom % of the second secondary component comprised in the shell is higher than an atom % of the second secondary component comprised in the core.

4. The multilayer ceramic capacitor of claim 3, wherein an atomic ratio of the second secondary component comprised in the shell to the second secondary component comprised in the core is in a range from 2 to 8.

5. The multilayer ceramic capacitor of claim 1, wherein samarium (Sm) is comprised in an amount ranging from 0.01 atom % to 1.2 atom % based on 100 atom % of titanium (Ti).

6. The multilayer ceramic capacitor of claim 1, wherein:
the dielectric grain comprises core and a shell surrounding at least a portion of the core;
samarium (Sm) is comprised in the core and the shell; and
an atom % of samarium (Sm) comprised in the shell is higher than an atom % of samarium (Sm) comprised in the core.

7. The multilayer ceramic capacitor of claim 6, wherein an atomic ratio of samarium (Sm) comprised in the shell to samarium (Sm) comprised in the core is in a range from 1.2 to 2.5.

8. The multilayer ceramic capacitor of claim 1, wherein the secondary component further comprises a third secondary component comprising aluminum (Al), silicon (Si), magnesium (Mg), manganese (Mn), or a combination thereof.

9. The multilayer ceramic capacitor of claim 8, wherein the third secondary component is comprised in an amount ranging from 0.1 atom % to 2.5 atom % based on 100 atom % of titanium (Ti).

10. The multilayer ceramic capacitor of claim 8, wherein the third secondary component comprises aluminum (Al) and silicon (Si).

11. The multilayer ceramic capacitor of claim 10, wherein an atomic ratio of the samarium (Sm) to a sum of aluminum (Al) and silicon (Si) is in a range from 0.01 to 0.7.

12. The multilayer ceramic capacitor of claim 8, wherein a diameter of the dielectric grain is in a range from 100 nm to 500 nm.

13. A manufacturing method of a multilayer ceramic capacitor, the manufacturing method comprising:
preparing a dielectric slurry by mixing a barium titanate-based primary component powder and secondary component powder comprising a samarium (Sm)-containing compound and a second secondary component containing compound;
manufacturing a dielectric green sheet by using the dielectric slurry, and forming a conductive paste layer on a surface of the dielectric green sheet;
manufacturing a dielectric green sheet laminate by stacking the dielectric green sheet on which the conductive paste layer is formed;
manufacturing a capacitor body comprising a dielectric layer and an internal electrode layer by firing the dielectric green sheet laminate; and
forming an external electrode on a first surface of the capacitor body,
wherein the second secondary component containing compound comprises a lanthanum (La)-containing compound, a cerium (Ce)-containing compound, a praseodymium (Pr)-containing compound, a neodymium (Nd)-containing compound, a promethium (Pm)-containing compound, a europium (Eu)-containing compound, a gadolinium (Gd)-containing compound, a terbium (Tb)-containing compound, a dysprosium (Dy)-containing compound, a holmium (Ho)-containing compound, an erbium (Er)-containing compound, a thulium (Tm)-containing compound, a ytterbium (Yb)-containing compound, a lutetium (Lu)-containing compound, or a combination thereof, and
wherein the second secondary component containing compound is comprised in an amount ranging from 1.2 parts by mole to 2.0 parts by mole based on 100 parts by mole of the barium titanate-based primary component powder.

14. The manufacturing method of claim 13, wherein the second secondary component containing compound comprises a terbium (Tb)-containing compound, a dysprosium (Dy)-containing compound, or a combination thereof.

15. The manufacturing method of claim 13, wherein the samarium (Sm)-containing compound is comprised in an amount ranging from 0.01 parts by mole to 1.2 parts by mole based on 100 parts by mole of the barium titanate-based primary component powder.

16. The manufacturing method of claim 13, wherein the secondary component powder further comprises a third secondary component containing compound comprising aluminum (Al)-containing compound, silicon (Si)-containing compound, magnesium (Mg)-containing compound, manganese (Mn)-containing compound, or a combination thereof.

17. The manufacturing method of claim 16, wherein the third secondary component containing compound is comprised in an amount ranging from 0.1 parts by mole to 2.5 parts by mole based on 100 parts by mole of the barium titanate-based primary component powder.

18. The manufacturing method of claim 16, wherein the third secondary component containing compound comprises the aluminum (Al)-containing compound and the silicon (Si)-containing compound.

19. A dielectric material having a dielectric grain comprising:
a primary component comprising a barium titanate-based compound;
a secondary component comprising:
a first secondary subcomponent comprising samarium, and
a second secondary subcomponent comprising a metal selected from the group consisting of lanthanum (La), cerium (Ce), praseodymium (Pr), neodymium (Nd), promethium (Pm), europium (Eu), gadolinium (Gd), terbium (Tb), dysprosium (Dy), holmium (Ho), erbium (Er), thulium (Tm), ytterbium (Yb), lutetium (Lu), and a combination thereof,
wherein the second secondary subcomponent is comprised in an amount ranging from 1.2 atom % to 2.0 atom % based on 100 atom % of titanium (Ti).

20. The dielectric material of claim 19, wherein the dielectric grain comprises a core and a shell surrounding at least a portion of the core, each comprising the second secondary subcomponent, and an atom % of the second secondary subcomponent comprised in the shell is higher than an atom % of the second secondary subcomponent comprised in the core.
